(19) United States
(12) Patent Application Publication
(10) Pub. No.: US 2003/0033218 A1
(43) Pub. Date: Feb. 13, 2003

(54) Method of supporting customizable solution bundles for e-commerce applications

(76) Inventors: David B. Flaxer, Yorktown Heights, NY (US); Yumman Chan, Rexdle (CA); Heung-Yang Chang, Scarsdale, NY (US)

Correspondence Address: Whitham, Curtis & Christofferson, P.C., Suite 340, 11491 Sunset Hills Road, Reston, VA, 20190, US

(21) Appl. No.: 09/927,269

(22) Filed: Aug. 13, 2001

(51) Int. Cl. G06F 17/60

(52) U.S. Cl. 705/27

(57) ABSTRACT

A method for defining and using customized bundled sets of products and services, associated with special characteristics such as discount pricing and industry personalized solutions, enhances revenue of web-based e-commerce applications. The consumer is provided the option of customizing the selection of individual marketable items into a bundle that best suits their need by implementing methodologies and tools that support the partitioning of a master product catalog into distinguished subsets called customizable solution bundles, that possess unique properties, business rules, and element characteristics. A customizable solution bundle presents significant advantages to both the vendor and to the consumer. For the vendor, this method allows the marketing organization to maximize profit and inventory control by assigning special price incentives to products and services contained within the solution bundle. In addition to the benefit of price incentives, the consumer is able to adapt, modify and customize a solution from a given set products and services known to achieve an end-to-end business solution for their industry.

### BACKGROUND OF THE INVENTION

1. Field of the Invention

The present invention generally relates to e-commerce applications which facilitate the marketing of products and services and, more particularly, to a method for defining and using bundled sets of products and services, associated with special characteristics such as discount pricing and industry personalized solutions, for the purposes of enhancing revenue of web-based e-commerce applications.

2. Background Description

In its most basic and simplest form, e-commerce applications enable the marketing of products and services by presenting views that list individual marketable items at specified prices. Typically, these marketable items are marshaled into a master catalog organized into some form of hierarchy and taxonomy best suited to the vendor's business. The consumer may elect to purchase selected items which are added to a designated area, notably a shopping cart or invoice, which is later used to fulfill and track the order.

It is at the discretion of the business to designate what a marketable item may be. In some cases in can be a basic atomic part that cannot stand alone in performing some anticipated unit of work. Such an atomic part must be integrated with other parts in order to provide meaningful service. In other cases, a marketable item can be an enumerated aggregation of all goods and services that delivers a complete solution to a specific business need. Such a complete solution is referred to as a fixed solution bundle. However, as the number of marketable items that comprise a solution grows, the potential for combinatorial increase of fixed solutions grows too—it is simply not feasible to offer fixed solutions tailored to meet all customers' business situations. Therefore, it is desirable to allow the consumer the option of customizing the selection of individual marketable items into a bundle that best suits their need. This is being done, for example, by a number of computer manufacturers which allow individual customers to customize a personal computer order by choosing among various hardware and software options and, optionally, adding peripherals, training and on-site service. However, this falls short of addressing the customer's business need for an industry personalized solution with discount pricing for customized bundled sets of products and services.

### SUMMARY OF THE INVENTION

It is therefore an object of the present invention to provide a method for defining and using customized bundled sets of products and services, associated with special characteristics such as discount pricing and industry personalized solutions.

According to the invention, the consumer is provided the option of customizing the selection of individual marketable items into a bundle that best suits their need by implementing methodologies and tools that support the partitioning of a master product catalog into distinguished subsets called customizable solution bundles, that possess unique properties, business rules, and element characteristics. A customizable solution bundle presents significant advantages to both the vendor and to the consumer. For the vendor, this method allows the marketing organization to maximize profit and inventory control by assigning special price incentives to products and services contained within the solution bundle. In addition to the benefit of price incentives, the consumer is able to adapt, modify and customize a solution from a given set products and services known to achieve an end-to-end business solution for their industry.

The distinction of this invention is the novel and unique adaptive reuse of methods and tools supporting a preexisting function called entitled groups which implements distinguished catalog subsets, but was never intended to support the requirements of customized solution bundles. By observing that customized solution bundles can be mapped into subset catalogs with entitled pricing and business rules applied, the implementation is simple and significantly straight forward. In fact, to the back-end fulfillment systems and ancillary e-commerce services a customized solution bundle looks no different and is essentially treated the same as any subset catalog with entitled price, provided that the fulfillment system and services recognize a unique encoding that identifies each marketable item to a subset catalog. We note both entitled groups and customized solution bundles support the concept to distinguished subsets; however, the functional requirements are significantly different between the two. Additionally, subset catalogs for group entitlement are exclusively dedicated to the distinguished membership they are created for. Customizable solution bundles, on the other hand, span all membership groups without restriction and the same instance of a solution bundle may be arbitrarily included for all customer types at the discretion of the marketing and sales administrators.

The following is a summary of the characteristics of a customizable solution bundle:

it is a uniquely distinguished subset of the master catalog,

it supports incentive discount pricing,

it has associated business rules that advise selection and pricing validity within the bundle,

it supports rapid definition and modification of a solution bundle and its properties by e-commerce administrators,

it allows the consumer to selectively adapt and customize products and services for purchase within the bundle, and

it maps to established business processes and tools known within the frontend and backend e-commerce system.

At the heart of the invention is a customizable solution bundle. A customizable solution bundle supports a marketing concept that possesses two key features:

1. A customizable solution bundle is a subset catalog of the master catalog containing preselected marketable elements that enable the customer to achieve its business objectives from and end-to-end perspective. The bundle represents the potential set of products that the marketing organization determines is suitable for a class of customer based on the experience gained by the marketing teams for that industry. By recommending products and guiding the customer through a solution, a significant sales advantage may result. The customer is allowed to select marketable items from this subset catalog in which to customize their solution. Solution bundles may be tailored to specific industries or other classifications of customers, and therefore, many solution bundles may be defined by a given vendor. For example, a solution bundle may include an unrestricted of various hardware components software, consulting services, maintenance, upgradable licence agreements, education, etc. (This is contrasted by the well known concept of a product configurator whose purpose is to aid the consumer in the customization of elements dedicated to a specific marketable item, such as the amount of memory to be installed within a given processor model.) Further, the solution bundle may be dedicated to a specific industry or and class of customer, for example a solution bundle to support a small legal or medical practice.

2. The most critical feature of a customizable solution bundle allows the marketing organization to drive economic advantage for profit maximization and inventory control by relating two or more marketable items within a solution bundle which, when selected by the customer, results in a pricing discount. A variety of differing pricing discounts may be applied against individual marketable elements or on the entire solution bundle as a whole, depending on rules applied. The application of a pricing discount is dependent on the selection the customer chooses at the time they are customizing their solution.

The definition of a customizable solution bundle contains several components: (1) a subset of master catalog; (2) incentive price discounts; (3) a specification of rules which determines pricing and customization validity of a bundle. (4) the specification of rules and/or content to assist the customer in the customized selection of items in their bundle.

The implementation of any e-commerce function is constrained by the business rules that are established with the vendors enterprise, and the customizable solution bundle function is no exception. Accordingly, two objectives must be met:

1. The marketing team must be able to rapidly define and maintain the subset catalog for the solution bundle and the associated pricing rules.

2. There must be catalog and pricing coherence and consistency between web-based front-end e-commerce application which presents information to the customer and the backend fulfillment systems and ancillary e-commerce services that helps establishes, accepts, accounts, and ships the order.

These objectives are similar to that supporting entitled groups, a currently enabled function that allows the marketing organization to subset catalog and assign discounted prices for group members. This function permits the marketing organization to apply arbitrary criteria to define subset catalog and pricing.

Entitled group support includes the implementation of sanctioned business process and tools to meet the objectives of rapid definition/maintenance and the coordination of definitions between the front-end and backend fulfillment systems. Both entitled group and customizable solution bundle functions possess the concept of subset catalog and pricing along with business processes and tools implement them. However, critical and distinguishing differences are as follows:

in entitled group support, the subset-catalog and prices apply only to the specific entitled group, and may not be applied to any excluded member;

customizable solution bundles span multiple groups and may be made available to any customer, at the discretion of the marketing organization; and

a customizable solution bundle supports a unique range of functions, including product customization and selection based on programmed business rules.

The core of this invention is the mapping of customizable solution bundles into a virtual entitled group that is processed, without distinction, by back end fulfillment systems and ancillary e-commerce services. A Customizable Solution Bundle is managed and mapped into a construct supporting entitled groups by front end e-commerce components and is transparently processed, in a similar manner supporting entitled groups, by back end fulfillment system components and ancillary e-commerce services. By consulting with each marketable item in order, fulfillment systems and services can determine the price and other item attributes in a common process.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block and flow diagram showing the data flow in the customizable solution bundle architecture according to the invention;

FIG. 2 is a block and flow diagram showing the order flow for the customizable solution bundle architecture;

FIG. 3 is an exemplary screen print of a user interface showing choices presented to the user for generating a customized bundle;

FIG. 4 is a menu of optional software bundles from which the user may choose in the example of FIG. 3; and

FIG. 5 is a block diagram showing the solution bundle constructs.

### DETAILED DESCRIPTION OF A PREFERRED EMBODIMENT OF THE INVENTION

To implement a solution bundle function, several key elements must be enabled:

1. A bundle definition process, where a solution bundle is created and loaded into the various components that support an e-commerce application, including the font- end and back-end fulfillment systems.

2. A user interface, a component of the e-commerce front end application, which presents the solution bundle configuration to the user and manages the order selection based on established bundle rules.

3. An order process, whereby the e-commerce application passes the solution bundle order to the back-end fulfillment systems for completion.

4. The recognition of a unique distinguished identifier, for each marketable item in the order that allows the front-end, back-end fulfillment and ancillary service components to associate the item to a given bundle, thereby resolving characteristics, including the incentive price of the item.

These items will be discussed in the following sections.

### Customizable Solution Bundle Architecture—Data Flow

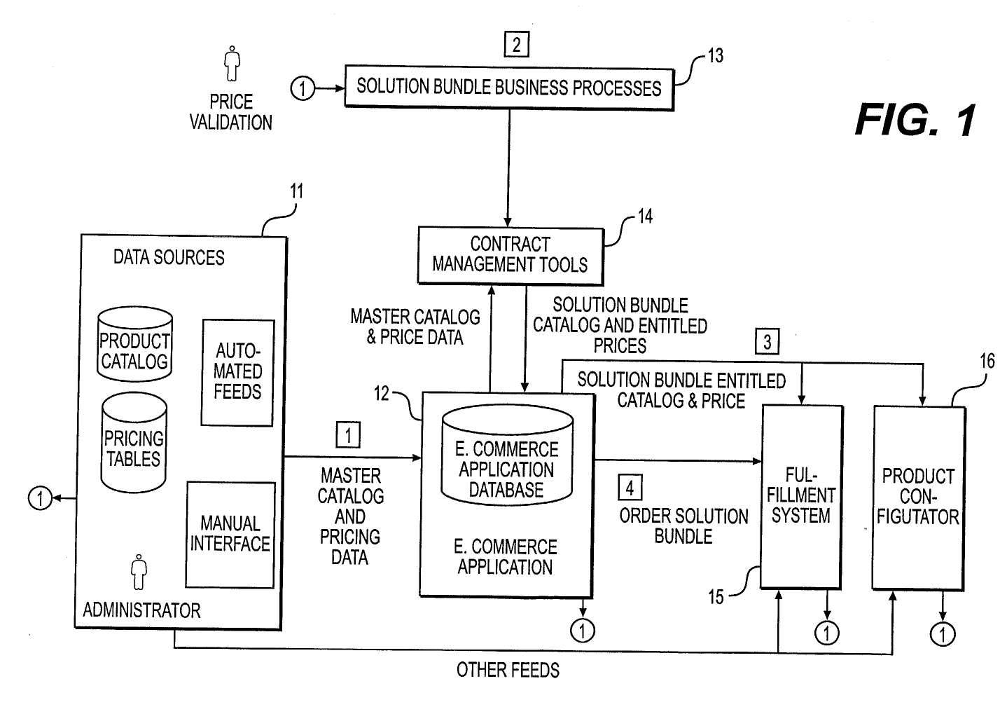

As shown in FIG. 1, the process of defining and maintaining a customizable solution bundle definition involves a close coupling of business processes and software applications and tools. First, an established catalog and price process loads data from data sources 11 into the e-commerce application 12. This is deemed the master catalog and contains no entitled or subset catalog definitions. The master catalog contains the entire universe of the vendor marketable items and is the base in which solution bundles may be defined. Prices are recorded as list prices without any discount. The Solution Bundle Business Process 13 is managed by the marketing organization. Managed by domain and subject matter experts, this process has the responsibility for defining solution bundle catalog subsets, entitled prices and bundle rules. Using automated and manual means, the owner of this process is also responsible for data validation and consistency throughout the system. Definition of the customizable solution bundle is entered into the e-commerce application 12 using a contract management tool supports 14. The contract management tool supports include:

view and subset of master catalog,

incentive price discounts, and

specification of pricing rules

Using established communication protocols, the e-commerce application 12 manages automated feed that sends the solution bundle definitions to backend systems including fulfillment system 15, product configurator 16 and other components. Each instance of a customizable solution bundle (consisting of catalog, prices and rules) is assigned a unique solution bundle identifier which is passed to the backend fulfillment systems and ancillary services. During e-commerce application use by a customer, orders for customizable solution bundles are forwarded to the fulfillment system from the e-commerce application.

### Customizable Solution Bundle Architecture—Order Flow

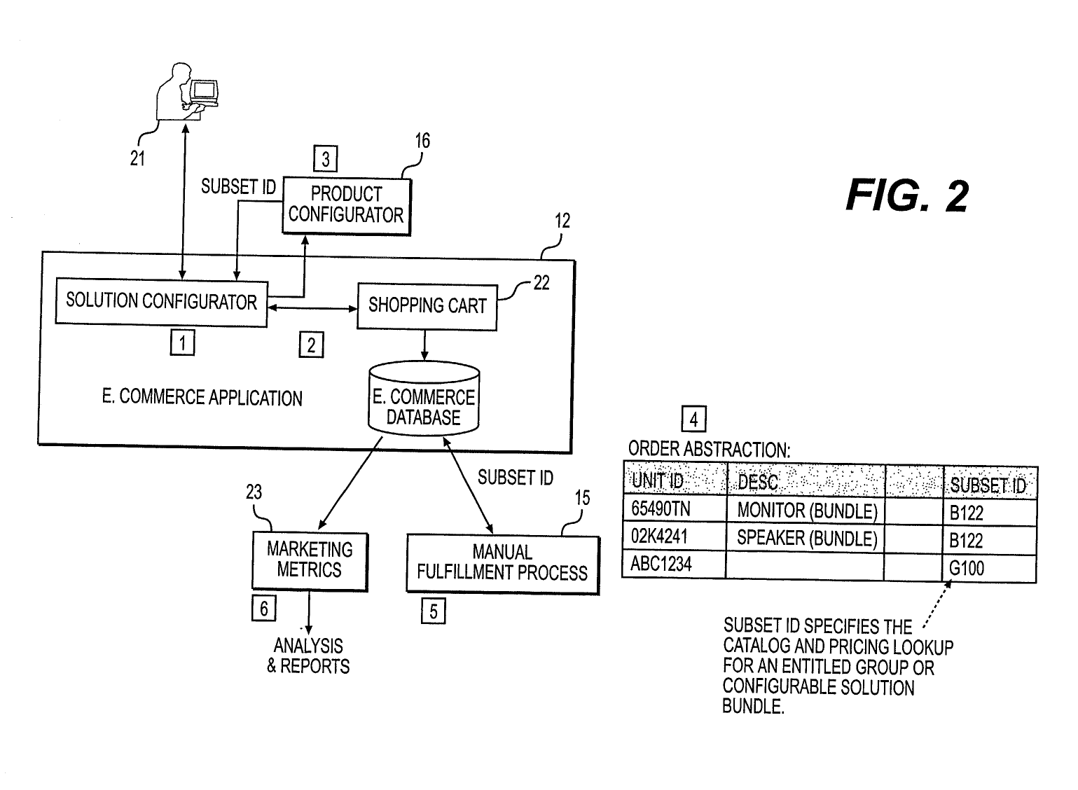

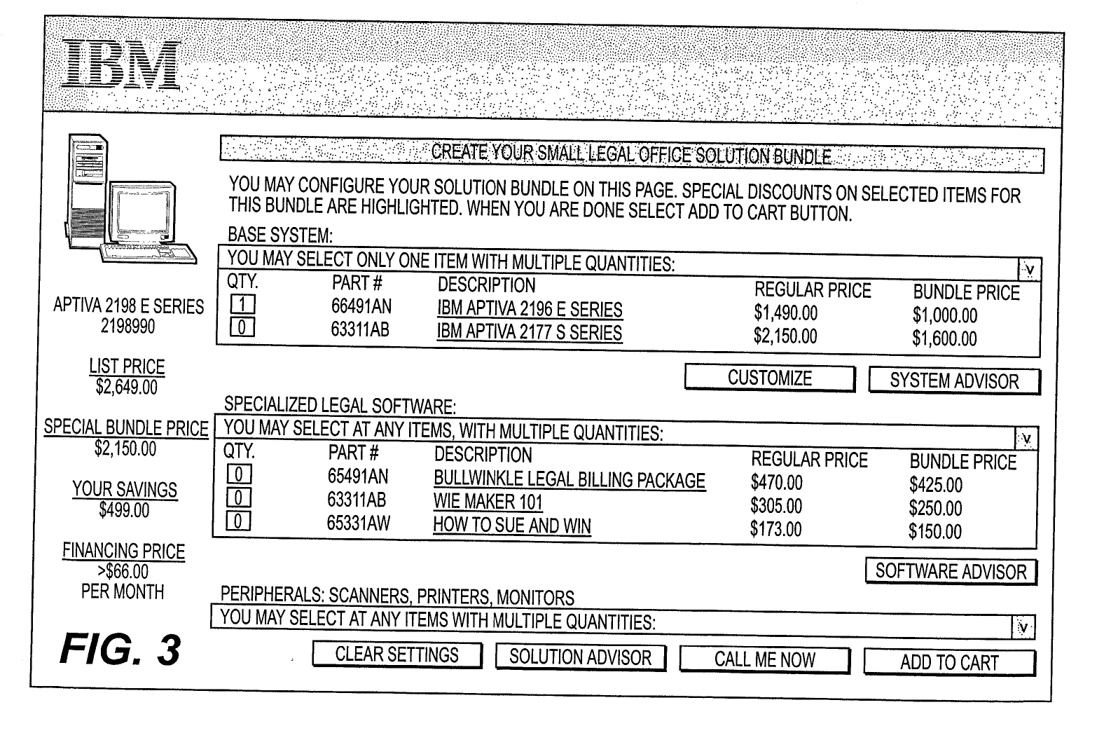

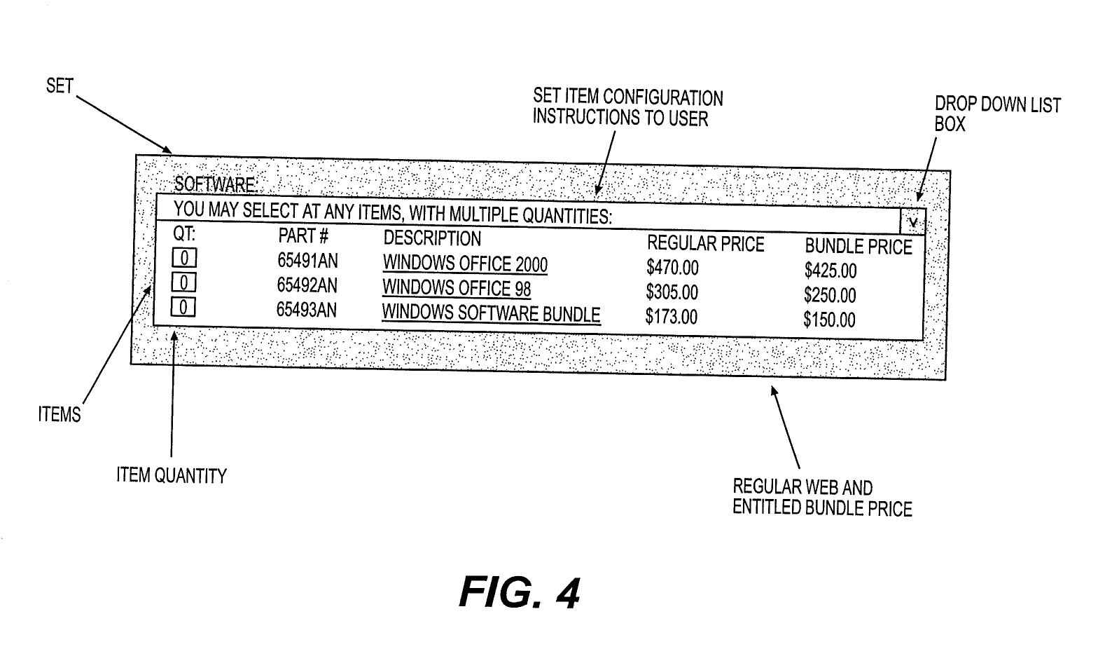

The order flow of the customizable solution bundle architecture is shown in FIG. 2. The order flow originates at the e-commerce application 12 which then passes the information to fulfillment systems 15 for order processing. Based on the data flow process presented in FIG. 1, both the front-end and backend fulfillment is cognizant of each distinguished customizable solution bundle sub-catalog and price structure. The e-commerce front end application 12 presents a user interface, an example of which is shown in FIG. 3, that supports the customizable solution bundle the user 21 specifies. In the example shown in FIG. 3, the screen presents the user 21 with a menu of items for creating a small legal office solution bundle. In the example illustrated, the user is first presented with a choice of two computer systems from which to choose, but only one can be selected; however, the user can select multiple quantities of the chosen system. The user is next presented with several choices of application software that may be selected, again in multiple quantities. In some cases, the selection of the base computer system may dictate the software choices available. As shown in FIG. 4, the user may also be provided a choice of software bundles, as well as specific software items. Finally, the user is presented with choices of various peripherals.

The interface manages the customizable order selection based on established bundle rules, and validates the order and pricing prior to submission to the backend fulfillment system 15. After reviewing the solution bundle that they have selected, the user 21 can add the validated order to shopping cart 22. Internally, a customizable solution bundle is represented by a series of individual marketable Rem entries annotated by the following critical pieces of information: (1) a item ID, and (2) a Subset ID representing and entitled group or solution bundle. Using this information, the fulfillment system 15 and ancillary services can determine the correct price for the item. A solution may contain many marketable items, including parts to be processed by product configurator. Since configurable products are deemed elements of a solution bundle, they are aggregated into the bundle when the order is placed. The product configurator 16 passes data back to the customizable solution bundle interface, and not the shopping cart. Each instance of a customizable solution bundle (consisting of catalog, prices and rules) is assigned a unique Subset ID which is passed to the backend fulfillment. The backend relies on the e-commence application 12 to validate the items in the bundle selection before submitting the order. The order is forwarded to fulfillment system 15, specifying Subset ID for every marketable item in the order. The fulfillment system 15 uses the Subset ID to determine the correct price and other characteristics for, the item. The marketing metrics 23 function performs analysis and reports on solution configuration usage based on Bundle ID function and other data.

### Solution Bundle Constructs

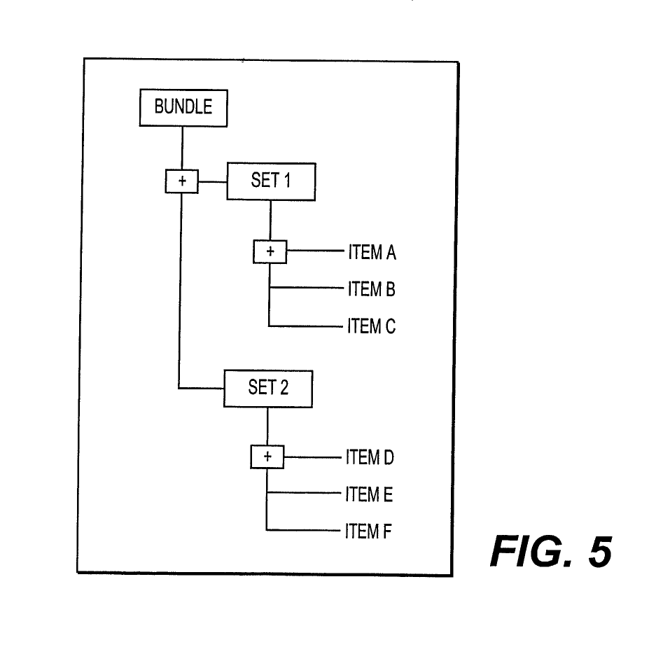

A solution bundle is generally illustrated in FIG. 5 as comprising one or more sets of one or more items. More particularly, a customizable solution bundle is defined as an entitled catalog, entitled price and rules that drive a valid configuration of products. From the end-user point of view, a bundle is represented as a customizable solution.

As indicated in FIG. 5, a bundle consists of one or more sets. A set is a logical grouping of products. Set examples are: Base models, Accessories, Communications, Multimedia, Software, Networking, Storage, etc. Also as indicated in FIG. 5, a set consists of one or more items. An item is a marketable item that is contained in the master catalog.

Bundle rules, specified by business and followed by user, are dynamically checked by the e-commerce user interface. An example of initial simplified set rules is as follows:

1. selection of an item within set by the user is optional, or

2. the user can choose only one item in the set, or

3. the user can choose multiple items in a set.

An example of Initial simplified item rules is as follows:

4. the user can order only one item, or

5. the user may order multiple items, and

6. some items (i.e., base models) may link to the product configurator.

Additional complex, cross dependent rules may also be applied.

### Example of User Interface

FIG. 3 is an example of an interface that supports a configurable solution bundle. This interface includes:

1. the concept of configurable sets and items driven and validated by established rules,

2. a mechanism for a user to obtain solution advice in context, and

3. clearly presented product selection and pricing information.

An interface can be realized by the front end e-commerce application or ancillary e-commerce services such as product configurator whose functions have been expanded to support configurable solution bundle requirements.

While the invention has been described in terms of a single preferred embodiment, those skilled in the art will recognize that the invention can be practiced with modification within the spirit and scope of the appended claims.

Having thus described our invention, what we claim as new and desire to secure by letters patent is as follows:

1. A method of supporting customizable solution bundles for e-commerce applications which enable the marketing of products and services by presenting to customers products and services in solution bundles as entitled groups comprising the steps of:
mapping customizable solution bundles into a virtual entitled group; and
processing the virtual entitled group, without distinction with other entitled groups, by back end fulfillment systems and ancillary e-commerce services.

2. The method of supporting customizable a solution bundles for e-commerce applications recited in claim 1, further comprising the step of recognizing a unique distinguished identifier, for each marketable item in a virtual entitled group that allows the front-end, back-end fulfillment and ancillary service components to associate an item with an incentive price of the item.

3. The method of supporting customizable a solution bundles for e-commerce applications recited in claim 2, wherein a customizable solution bundle is mapped into a subset catalog of the master catalog containing preselected marketable elements.

4. A method of supporting customizable a solution bundles for e-commerce applications comprising the steps of:
providing a bundle definition process, where a solution bundle is created and loaded into the various components that support an e-commerce application, including the font-end and back-end application fulfillment systems;
mapping customizable solution bundles into a virtual entitled group and processing the virtual entitled group, without distinction with other entitled groups, by back-end fulfillment systems and ancillary e-commerce services;
providing a user interface as a component of the e-commerce front-end application, which presents a solution bundle configuration to the user and manages an order selection based on established bundle rules;
providing an order process, whereby the e-commerce application passes the solution bundle order to the back-end application fulfillment systems for completion; and
recognizing a unique distinguished identifier, for each marketable item in an order that allows the front-end, back-end fulfillment and ancillary service components to associate an item to a given bundle, thereby resolving characteristics, including an incentive price of the item.

5. The method of supporting customizable a solution bundles for e-commerce applications recited in claim 4, wherein a customizable solution bundle is mapped into a subset catalog of the master catalog containing preselected marketable elements that represents a potential set of products that a marketing organization determines what is suitable for a class of customer based on experience gained by marketing teams for that industry.

6. The method of supporting customizable a solution bundles for e-commerce applications recited in claim 4, further comprising the step of recommending products and guiding the customer through a solution, whereby the customer is allowed to select marketable items from the subset catalog in which to customize their solution.

7. The method of supporting customizable a solution bundles for e-commerce applications recited in claim 6, wherein solution bundles are tailored to specific industries or classifications of customers, whereby many solution bundles may be defined by a given vendor.

8. The method of supporting customizable a solution bundles for e-commerce applications recited in claim 7, wherein the solution bundle is dedicated to a specific industry or class of customer.

9. The method of supporting customizable a solution bundles for e-commerce applications recited in claim 8, wherein a solution bundle which, when selected by the customer, results in a pricing discount.

10. The method of supporting customizable a solution bundles for e-commerce applications recited in claim 9, wherein a variety of differing pricing discounts are applied against individual marketable elements or on the entire solution bundle as a whole, depending on rules applied, the application of a pricing discount being dependent on a selection the customer chooses at the time they are customizing their solution.
